(19) United States
(12) Patent Application Publication
(10) Pub. No.: US 2017/0130412 A1
(43) Pub. Date: May 11, 2017

(54) FOREIGN MATTER REMOVING DEVICE FOR USE IN TURNOUT, AND METHOD FOR INSTALLING FOREIGN MATTER REMOVING DEVICE FOR USE IN TURNOUT

(71) Applicant: NABTESCO CORPORATION, Tokyo (JP)

(72) Inventors: Shogo KIGAMI, Hyogo (JP); Yuki KINUGASA, Hyogo (JP); Koji SATO, Hyogo (JP)

(21) Appl. No.: 14/937,252

(22) Filed: Nov. 10, 2015

(51) Int. Cl. E01H 8/12; E01B 37/00; E01B 7/14; B08B 3/02; B08B 5/02

(52) U.S. Cl. CPC E01H 8/125; B08B 3/02; B08B 5/02; E01B 7/14; E01B 37/00

(57) ABSTRACT

A foreign matter removing device Y1 for use in a turnout X1 is provided with a base rail 100 and a tongue rail 200. The foreign matter removing device Y1 is provided with an inlet member 4 including an inlet channel 44, the inlet member 4 extending in the width direction of the base rail 100 in a region lower than a bottom surface B1 of the base rail 100; and a connecting portion 22 including a communication channel 22c for communicating a nozzle portion 21 which injects a foreign matter removable medium to between the base rail 100 and the tongue rail 200, and the inlet channel 44. The connecting portion 22 is connected to one end portion 41 of the inlet member 4 in the region lower than the bottom surface B1 of the base rail 100. The other end portion 42 of the inlet member 4 disposed on the outside of the bottom surface B1 of the base rail 100 in top plan view is configured such that the operator can hold the one end portion 41 in a state that the one end portion 41 does not fall off from the connecting portion 22.

### BACKGROUND OF THE INVENTION

### Field of the Invention

The present invention relates to a foreign matter removing device for use in a turnout, and a method for installing a foreign matter removing device for use in a turnout.

### Description of Background Art

Conventionally, a turnout of railways is provided with base rails, and tongue rails disposed adjacent to the base rails. The turnout is configured such that moving the tongue rails toward and away from the base rails makes it possible to change the traveling direction of a train passing through the turnout. When the turnout is installed in e.g. a snowfall area, foreign matter such as frozen snow may be deposited between the base rails and the tongue rails. If foreign matter such as frozen snow is deposited between the base rails and the tongue rails, the tongue rails may be unable to come into contact with the base rails. In view of the above, Patent Literature 1 (International Unexamined Patent Publication No. 2013/038657) and Patent Literature 2 (Japanese Unexamined Patent Publication No. 2000-144602) propose foreign matter removing devices for removing foreign matter from between the base rails and the tongue rails.

The foreign matter removing device disclosed in Patent Literature 1 is, as illustrated in FIG. 11, provided with a joint portion 74 extending from the side opposite to a tongue rail 72 with respect to a base rail 71 to a region lower than a bottom surface 73 of the base rail 71; a bent portion 75 joined to a tongue-rail-72-side end of the joint portion 74; and a nozzle portion 76 joined to the bent portion 75, and disposed between the base rail 71 and the tongue rail 72. The foreign matter removing device disclosed in Patent Literature 1 is configured such that compressed air fed from an air tank as an external device to the joint portion 74 is injected through the nozzle portion 76 via the bent portion 75. In this way, foreign matter such as frozen snow deposited between the base rails 71 and the tongue rails 72 is removed.

The foreign matter removing device disclosed in Patent Literature 2 is, as illustrated in FIG. 12, provided with a pipe joint portion 83 extending from the side opposite to a tongue rail with respect to a base rail 81 to a region lower than a bottom surface 82 of the base rail 81; a prismatic pipe 84 joined to a tongue-rail-side end of the pipe joint portion 83, and extending along the length direction of each rail between the base rail 81 and the tongue rail; and a nozzle portion formed in the prismatic pipe 84. The pipe joint portion 83 is divided into one part 83a and the other part 83b in the region lower than the bottom surface 82 of the base rail 81. The one part 83a and the other part 83b are fixed to each other by screw members 85. In the foreign matter removing device disclosed in Patent Literature 2, compressed air fed from a compressed air source device as an external device to the pipe joint portion 83 is injected through the nozzle portion via the prismatic pipe 84. In this way, foreign matter such as frozen snow deposited between the base rails 81 and the tongue rails is removed.

In the foreign matter removing device disclosed in Patent Literature 1, for instance, when the joint portion 74, the bent portion 75, and the nozzle portion 76 are integrally formed, it is difficult to install the foreign matter removing device in a turnout. Specifically, when the distance between the base rail 71 and the tongue rail 72 is relatively narrow, it is difficult to insert the joint portion 74 of the foreign matter removing device integrally formed of the joint portion 74, the bent portion 75, and the nozzle portion 76 into a region lower than the bottom surface 73 of the base rail 71 from between the base rail 71 and the tongue rail 72. As a method for installing the foreign matter removing device integrally formed of the joint portion 74, the bent portion 75, and the nozzle portion 76 in the turnout, there is proposed a method, in which the operator inserts the nozzle portion 76, the bent portion 75, and the joint portion 74 into the region lower than the base rail 71 from the side opposite to the tongue rail 72 with respect to the base rail 71, and then, the operator mounts the nozzle portion 75 between the base rail 71 and the tongue rail 72. However, when the turnout is applied to a slab track, for instance, it is difficult to insert the nozzle portion 76 and the bent portion 75 into the space lower than the bottom surface 73 of the base rail 71, because the space is narrow.

Further, in the foreign matter removing device disclosed in Patent Literature 2, the pipe joint portion 83 is divided into the one part 83a and the other part 83b in the region lower than the bottom surface 82 of the base rail 81. Therefore, when the foreign matter removing device disclosed in Patent Literature 2 is installed in a turnout, for instance, the operator places the one part 83a, the prismatic pipe 84, and the nozzle portion in an integrally formed state at a predetermined installation position from between the base rail 81 and the tongue rail. Then, the operator inserts the other part 83b into the region lower than the base rail 81 from the side opposite to the tongue rail with respect to the base rail 81. According to this configuration, it is easy for the operator to install the foreign matter removing device in the turnout, even when the space lower than the bottom surface 82 of the base rail 81 is narrow. However, when the foreign matter removing device disclosed in Patent Literature 2 is installed in the turnout by the aforementioned method, it is required to fix the one part 83a and the other part 83b to each other by the screw members 85 in the region lower than the bottom surface 82 of the base rail 81. This may lower the work efficiency.

### SUMMARY OF THE INVENTION

In view of the above, an object of the invention is to provide a foreign matter removing device for use in a turnout, which enables to facilitate installation while preventing lowering the work efficiency, and a method for installing the foreign matter removing device for use in a turnout.

A foreign matter removing device for use in a turnout according to an aspect of the invention is a foreign matter removing device for use in a turnout, wherein the foreign matter removing device is provided with a base rail, and a tongue rail disposed adjacent to the base rail and movable toward and away from the base rail. The foreign matter removing device is provided with an inlet member including an inlet channel for introducing a foreign matter removable medium, the inlet member extending in a width direction of the base rail in a region lower than a bottom surface of the base rail; and a connecting portion including a communication channel for communicating a nozzle portion which injects the foreign matter removable medium to between the base rail and the tongue rail, and the inlet channel. The connecting portion is connected to one end portion of the inlet member in the region lower than the bottom surface of the base rail. The other end portion of the inlet member disposed on the outside of the bottom surface of the base rail in top plan view is configured such that an operator is allowed to connect the one end portion of the inlet member to the connecting portion.

These and other objects, features and advantages of the present invention will become more apparent upon reading the following detailed description along with the accompanying drawings.

### BRIEF DESCRIPTION OF THE DRAWINGS

FIG. 1 is a schematic configuration diagram of a turnout, foreign matter removing devices, and a compressed air source according to an embodiment of the invention;

FIG. 2 is a perspective view illustrating the schematic configuration of the foreign matter removing device according to the embodiment, specifically, illustrating a state that the foreign matter removing device is mounted on a base rail;

FIG. 3 is a perspective view illustrating the schematic configuration of the foreign matter removing device according to the embodiment, as viewed from the side opposite to FIG. 2, specifically, illustrating a state that the foreign matter removing device is mounted on the base rail;

FIG. 4 is a side view illustrating the schematic configuration of the foreign matter removing device according to the embodiment;

FIG. 5 is an essential part sectional view of the foreign matter removing device according to the embodiment, specifically, a diagram in which illustration of a holding plate and a pulling member is omitted;

FIG. 6 is a side view illustrating the schematic configuration of a modification of the foreign matter removing device according to the embodiment;

FIG. 7 is a diagram illustrating the schematic configuration of another modification of the foreign matter removing device according to the embodiment, specifically, a front view of a connecting portion as viewed from the tongue rail side;

FIG. 8 is an essential part perspective view illustrating the schematic configuration of another modification of the foreign matter removing device according to the embodiment, specifically, illustrating a state before one end portion of an inlet member is held on a connecting portion of an outlet member;

FIG. 9 is an essential part front view of a lower end of the connecting portion in the modification illustrated in FIG. 8;

FIG. 10 is a side view illustrating the schematic configuration of yet another modification of the foreign matter removing device according to the embodiment;

FIG. 11 is a side view illustrating the schematic configuration of the foreign matter removing device disclosed in Patent Literature 1; and

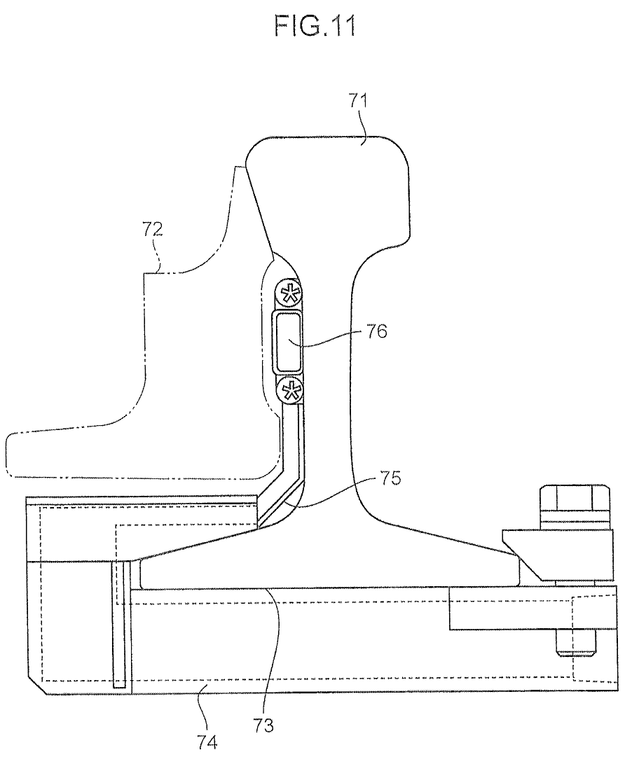

FIG. 12 is a side view illustrating the schematic configuration of the foreign matter removing device disclosed in Patent Literature 2.

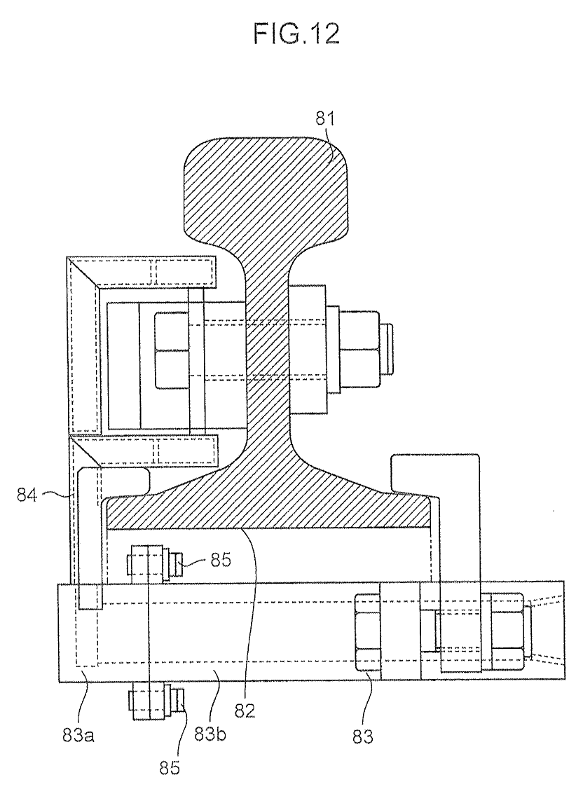

### DETAILED DESCRIPTION OF THE PREFERRED EMBODIMENT

In the following, an embodiment of the invention is described in detail referring to the drawings. The following embodiment is an example embodying the invention, and does not limit the technical scope of the invention.

Each of the drawings to be referred to in the following description briefly illustrates the primary members necessary for describing the embodiment among the constituent members of the embodiment of the invention in order to simplify the description.

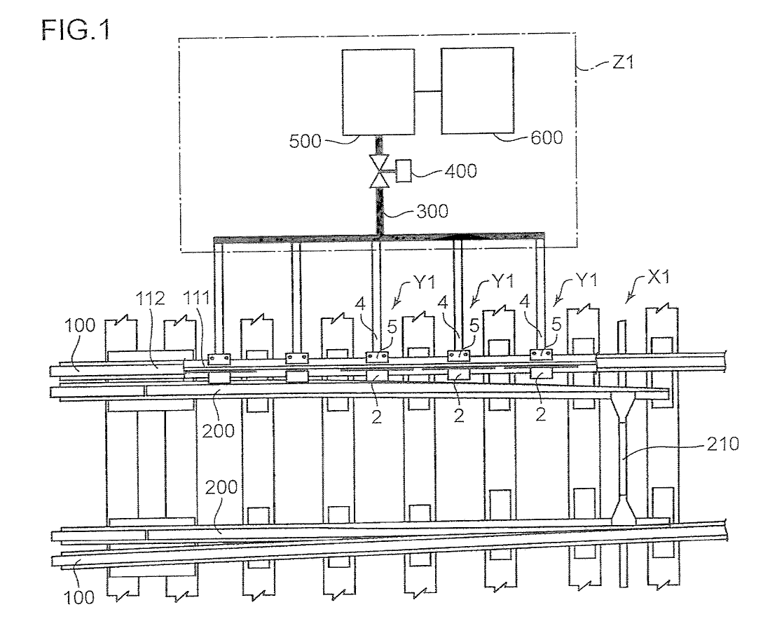

FIG. 1 illustrates a turnout X1, which is a portion where the track of a train is branched, foreign matter removing devices Y1 installed in the turnout X1, and a compressed air source Z1 for supplying compressed air to the foreign matter removing devices Y1.

The turnout X1 is a portion at which the traveling direction of a train is switched on the track of the train. In the embodiment, the turnout X1 is applied to a ballast track configured such that a number of railway sleepers are aligned, and the ground between the sleepers is graveled. The turnout X1 may be applied to a slab track.

The turnout X1 includes a pair of base rails 100 disposed away from each other by a predetermined distance, and a pair of tongue rails 200 disposed between the base rail pair 100. The tongue rails 200 are disposed adjacent to the base rails 100 in the width direction of the base rail 100. The tongue rails 200 are movable toward and away from the base rails 100 when the tongue rails 200 are moved in the width direction of the base rail 100. Specifically, one switch rod 210 is commonly mounted on tip ends of the tongue rail pair 200. Operating the switch rod 210 by an unillustrated point switching device allows for the tongue rail pair 200 to move in the width direction between the base rail pair 100 in a state that the distance between the tongue rail pair 200 is kept unchanged. According to this configuration, the turnout X1 is switched between a state that one of the tongue rails 200 is moved toward one of the base rails 100 whereas the other of the tongue rails 200 is moved away from the other of the base rails 100, and a state that the other of the tongue rails 200 is moved toward the other of the base rails 100 whereas the one of the tongue rails 200 is moved away from the one of the base rails 100.

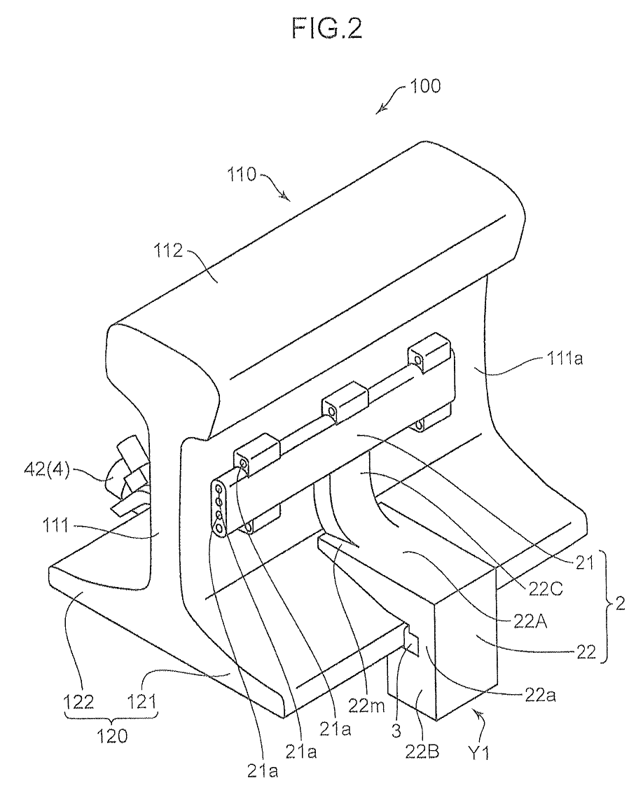

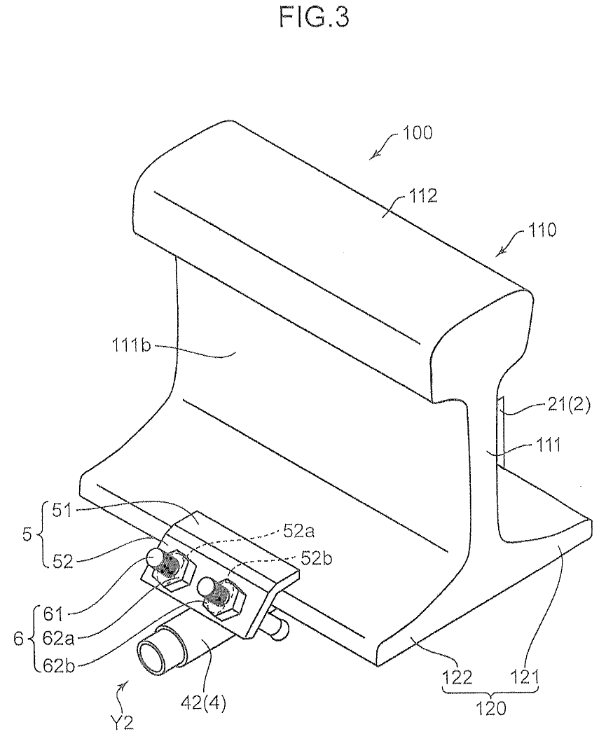

As illustrated in FIG. 2 to FIG. 4, each of the base rails 100 includes a rail main body 110 and a leg portion 120.

The rail main body 110 includes a first portion 111 and a second portion 112. The first portion 111 is a vertically extending portion of the rail main body 110, and supports the second portion 112. The first portion 111 includes a first side surface 111a formed on the tongue rail 200 side, and a second side surface 111b formed on the side opposite to the first side surface 111a. The second portion 112 is joined to the upper end of the first portion 111. The second portion 112 is formed to have a larger width than the first portion 111 in the width direction of the base rail 100. The wheels of a train roll on the upper surface of the second portion 112. Further, the second portion 112 is a portion which comes into contact with the tongue rail 200. When the tongue rail 200 is kept in contact with the second portion 112 of the base rail 100, there is formed a clearance between the tongue rail 200, and the first side surface 111a of the first portion 111. In FIG. 1, illustration of the second portion 112 of one of the base rail pair 100 is omitted.

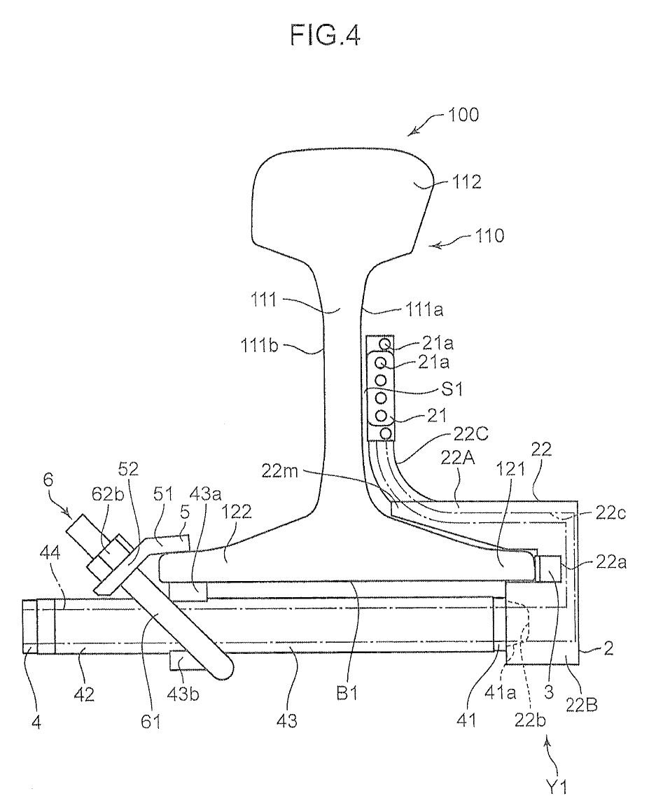

The leg portion 120 is a portion that supports the rail main body 110. The leg portion 120 is joined to the lower end of the first portion 111. The leg portion 120 includes a first leg portion 121 extending from the rail main body 110 toward the tongue rail 200 side in the width direction of the base rail 100, and a second leg portion 122 extending toward the side opposite to the first leg portion 121. The lower surface of the leg portion 120 serves as a bottom surface B1 of the base rail 100. As illustrated in FIG. 4, there is formed a clearance between the bottom surface Bl of the base rail 100, and the ground below the bottom surface B1.

The foreign matter removing device Y1 is a device for removing foreign matter such as frozen snow deposited between the base rails 100 and the tongue rails 200. In the embodiment, as illustrated in FIG. 1, a plurality of the foreign matter removing devices Y1 are disposed away from each other at a predetermined interval along the length direction of the base rail 100. The foreign matter removing devices Y1 are mounted on the base rail 100 at a position between the railway sleepers constituting a ballast track. In FIG. 1, only the foreign matter removing devices Y1 mounted on one of the base rail pair 100 are illustrated. It should be noted that the foreign matter removing devices Y1 are also mounted on the other of the base rail pair 100 in the same manner as described above.

The foreign matter removing device Y1 injects compressed air to be supplied from the compressed air source Z1 to between the base rail 100 and the tongue rail 200. Specifically, the compressed air source Z1 is provided with a connection pipe 300 commonly connected to the foreign matter removing devices Y1, an electromagnetic valve 400 that is configured to open and close the connection pipe 300, an air tank 500 connected to the connection pipe 300 at a position upstream of the electromagnetic valve 400, and a compressor 600 connected to the air tank 500. The compressed air source Z1 introduces air in the air tank 500, which has undergone compression by the compressor 600, to each of the foreign matter removing devices Y1 through the connection pipe 300 by opening the electromagnetic valve 400. Each of the foreign matter removing devices Y1 injects the compressed air introduced from the compressed air source Z1 to between the base rail 100 and the tongue rail 200 for removing foreign matter such as frozen snow.

In the embodiment, compressed air is introduced to the foreign matter removing devices Y1, as a foreign matter removable medium for removing foreign matter such as frozen snow. The embodiment is not limited to the above. For instance, introducing warm water as a foreign matter removable medium to the foreign matter removing devices Y1, and melting the foreign matter such as frozen snow deposited between the base rails 100 and the tongue rails 200 makes it possible to remove the foreign matter.

As illustrated in FIG. 2 to FIG. 4, the foreign matter removing device Y1 includes an outlet member 2, a shim member 3, an inlet member 4, a holding plate 5, and a pulling member 6.

The outlet member 2 is a member for drawing out compressed air that is introduced from the compressed air source Z1 to the foreign matter removing device Y1. The outlet member 2 includes a nozzle portion 21 and a connecting portion 22. In the embodiment, the nozzle portion 21 and the connecting portion 22 are integrally formed.

The nozzle portion 21 is a portion for injecting compressed air to between the base rail 100 and the tongue rail 200. The nozzle portion 21 is disposed between the tongue rail 200 and the base rail 100. In the embodiment, the nozzle portion 21 is a flat member, and has a substantially rectangular shape in plan view. The nozzle portion 21 is disposed to extend along the first side surface 111a of the first portion 111 of the rail main body 110. A clearance S1 is formed between the nozzle portion 21 and the first side surface 111a. The nozzle portion 21 and the first side surface 111a may come into contact with each other.

The nozzle portion 21 includes a plurality of injection ports 21a for injecting compressed air. The injection ports 21a are opened toward a longitudinal end surface of the nozzle portion 21 so that compressed air is injected in the length direction of the base rail 100.

The connecting portion 22 is a member for connecting the nozzle portion 21 and the inlet member 4. The connecting portion 22 is joined to the nozzle portion 21, and extends downward with respect to the nozzle portion 21. Specifically, as illustrated in FIG. 2, the connecting portion 22 has a smaller width than the nozzle portion 21 in the length direction of the base rail 100.

The connecting portion 22 includes an upper end 22A disposed above the first leg portion 121, a lower end 22B disposed on the side opposite to the upper end 22A with respect to the first leg portion 121, and a joint portion 22C for connecting the upper end 22A and the nozzle portion 21.

The upper end 22A extends in the width direction of the base rail 100. The lower end 22B is disposed in a region lower than the bottom surface B1. The connecting portion 22 is formed to extend along the first side surface 111a of the first portion 111, the first leg portion 121, and the bottom surface B1 from the upper end 22A to the other end 22B. The upper end 22A and the lower end 22B vertically sandwich the first leg portion 121 therebetween. The size of each of the upper end 22A and the lower end 22B in the length direction of the base rail 100 is slightly larger than the diameter of the inlet member 4.

The joint portion 22C connects the end of the upper end 22A on the side opposite to the tongue rail 200 in the width direction of the base rail 100, namely, a tip end 22m of the upper end 22A most proximate to the first portion 111; and the lower end of the middle portion of the substantially rectangular nozzle portion 21 in the length direction of the base rail 100. According to this configuration, the joint portion 22C extends vertically. In the embodiment, the width of the joint portion 22C is slightly smaller than the width of the upper end 22A and of the lower end 22B in the length direction of the base rail 100.

The connecting portion 22 includes an opposing portion 22a, a female screw portion 22b, and a communication channel 22c.

The opposing portion 22a is a portion to be joined to the upper end 22A and the other end 22B. The opposing portion 22a faces the first leg portion 121 in the width direction of the base rail 100.

The opposing portion 22a includes an opposing surface facing the first leg portion 121 in the width direction of the base rail 100. The shim member 3 is mounted on the opposing surface. The shim member 3 is sandwiched between the first leg portion 121 and the opposing portion 22a in the width direction of the base rail 100. The shim member 3 may be omitted, and the first leg portion 121 and the opposing surface of the opposing portion 22a may directly come into contact with the each other in the width direction of the base rail 100.

The female screw portion 22b is a portion to be engaged with a male screw portion 41a of the inlet member 4 to be described later. The female screw portion 22b is disposed in a region lower than the bottom surface B1. Specifically, the female screw portion 22b is formed by recessing a part of the inlet-member-4-side surface of the lower end 22B in the width direction of the base rail 100 toward the tongue rail 200 side. The female screw portion 22b is formed in the middle portion of the connecting portion 22 in the length direction of the base rail 100. In the embodiment, the female screw portion 22b is formed in a region lower than the bottom surface B1. The embodiment is not limited to the above, as far as the female screw portion 22b is formed in a region lower than the bottom surface B1. Specifically, the female screw portion 22b may be formed in a region lower than the imaginary plane horizontally extending from the bottom surface B1.

The communication channel 22c is a channel for communicating each of the injection ports 21a of the nozzle portion 21 with an inlet channel 44 of the outlet member 2 to be described later. The communication channel 22c is commonly communicated with each of the injection ports 21a, and is opened toward the female screw portion 22b.

The inlet member 4 is a member for introducing compressed air from the compressed air source Z1. The inlet member 4 includes one end portion 41, the other end portion 42, an intermediate portion 43 between the one end portion 41 and the other end portion 42, and the inlet channel 44 linearly extending from the one end portion 41 to the other end portion 42. The inlet member 4 is constituted of a pipe member having a linear shape from the one end portion 41 to the other end portion 42.

The one end portion 41 of the inlet member 4 is disposed in the region lower than the bottom surface B1 of the base rail 100. The one end portion 41 includes the male screw portion 41a. The male screw portion 41a has a tapered shape toward the tip end of the one end portion 41. Further, the male screw portion 41a is engaged in the female screw portion 22b. According to this configuration, the one end portion 41 is connected to the connecting portion 22. In this state, the one end portion 41 is held in a state that the one end portion 41 does not fall off from the connecting portion 22 in the width direction of the base rail, and the inlet channel 44 opened toward the male screw portion 41a is communicated with the communication channel 22c opened toward the female screw portion 22b.

The other end portion 42 of the inlet member 4 is disposed on the outside of the bottom surface B1 of the base rail 100 in top plan view, and extends in the width direction of the base rail 100. According to this configuration, the other end portion 42 serves as a portion capable of being held by the operator, when the operator connects the one end portion 41 to the connecting portion 22. Specifically, the other end portion 42 is a portion capable of being held by the operator, when the operator engages the male screw portion 41a in the female screw portion 22b. The operator who installs the foreign matter removing device Y1 can pivot the other end portion 42 while holding the other end portion 42 on the outside of the bottom surface B1 of the base rail 100 in top plan view, and can engage the male screw portion 41a in the female screw portion 22b. Thus, the operator can connect the one end portion 41 to the connecting portion 22. The other end portion 42 is connected to the connection pipe 300 of the compressed air source Z1. Compressed air is introduced to the inlet channel 44 opened toward the other end portion 42 through the connection pipe 300.

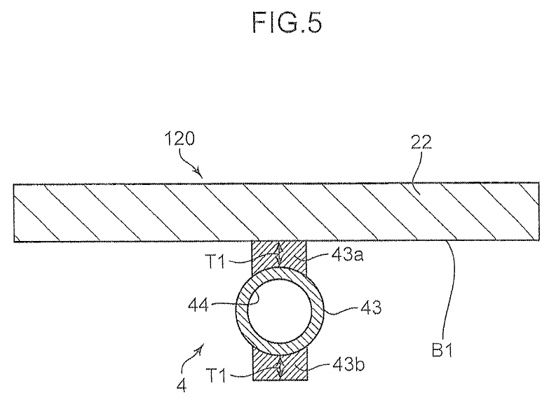

The intermediate portion 43 of the inlet member 4 is disposed in the region lower than the bottom surface B1 between the one end portion 41 and the other end portion 42. As illustrated in FIG. 4 and FIG. 5, the intermediate portion 43 includes a first projection 43a and a second projection 43b. The first projection 43a vertically projects in one direction. The second projection 43b projects toward the side opposite to the first projection 43a. Specifically, the first projection 43a and the second projection 43b are disposed to be away from each other with a phase difference of 180° around the axis of the inlet member 4. In the embodiment, the first projection 43a comes into contact with the bottom surface B1, and a U-bolt 61 of the pulling member 6 to be described later is hooked onto the second projection 43b. The first projection 43a and the second projection 43b are formed independently of each other, and have substantially the same thickness T1.

In the embodiment, the first projection 43a projects vertically upward. The embodiment is not limited to the above. The first projection 43a may project vertically downward. In this case, the second projection 43b comes into contact with the bottom surface B1, and the U-bolt of the pulling member 6 to be described later is hooked onto the first projection 43a.

Further, in the embodiment, the intermediate portion 43 includes two projections i.e. the first projection 43a and the second projection 43b. The embodiment is not limited to the above. The intermediate portion 43 may include one projection, or more than two projections. Further, in the embodiment, the first projection 43a and the second projection 43b are disposed to be away from each other with a phase difference of 180° around the axis of the inlet member 4. The phase difference between the projections is not limited to the above. For instance, the projections may be disposed to be away from each other with a phase difference of 90°.

The holding plate 5 and the pulling member 6 are members for fixing the foreign matter removing device Y1 to the base rail 100.

The holding plate 5 includes a pressing portion 51 and a tilt portion 52. The pressing portion 51 is disposed to come into contact with the upper surface of the second leg portion 122. The pressing portion 51 is a portion for pressing the second leg portion 122 from above. The tilt portion 52 is joined to the pressing portion 51. The tilt portion 52 extends from the pressing portion 51 to be inclined downward toward the side opposite to the first leg portion 121 in the width direction of the base rail 100. The tilt portion 52 is formed with oblong holes 52a and 52b extending along the tilt direction of the tilt portion 52. The oblong holes 52a and 52b are formed to sandwich the inlet member 4 therebetween in top plan view.

The pulling member 6 includes the U-bolt 61, and nuts 62a and 62b. A bent portion of the U-bolt 61 is hooked onto the second projection 43b, and both ends of the U-bolt 61 are respectively received in the oblong holes 52a and 52b. Both ends of the U-bolt 61 received in the oblong holes 52a and 52b are respectively fastened by the nuts 62a and 62b. According to this configuration, the pulling member 6 is fixed to the tilt portion 52 in a state that the U-bolt 61 extends in a direction orthogonal to the tilt portion 52.

The U-bolt 61 exerts a force on the second projection 43b in a state that the U-bolt 61 is fixed to the tilt portion 52 by the nuts 62a and 62b. According to this configuration, the pulling member 6 pulls the inlet member 4 toward the other end portion 42 side in the width direction of the base rail 100, utilizing the counterforce of the holding plate 5. As the pulling member 6 pulls the inlet member 4, a pulling force is also exerted on the outlet member 2 connected to the inlet member 4. This allows for the opposing portion 22a to be pressed against the first leg portion 121, while interposing the shim member 3 in the width direction of the base rail 100. In this way, the holding plate 5 and the pulling member 6 cause the opposing portion 22a to be pressed against the first leg portion 121. In this way, the foreign matter removing device Y1 is mounted on the base rail 100.

Next, a method for installing the foreign matter removing device Y1 is described.

1) Disposing Step

First of all, the operator inserts the outlet member 2 from above into between the base rail 100 and the tongue rail 200. When the operator carries out this operation, the operator inserts the lower end 22B of the connecting portion 22 into the region lower than the bottom surface B1 of the base rail 100. Subsequently, the operator stops the insertion at a position where the first leg portion 121 faces the opposing portion 22a in the width direction of the base rail 100. Then, the operator disposes the connecting portion 22 at such a position that the upper end 22A and the lower end 22B vertically sandwich the first leg portion 121. By performing the aforementioned operation, the female screw portion 22b formed in the lower end 22B is disposed to be recessed toward the tongue rail 200 side in the width direction of the base rail 100 in a region lower than the bottom surface B1.

2) Connecting Step

Subsequently, the operator inserts the one end portion 41 of the inlet member 4 into the region lower than the bottom surface B1 from the second leg portion 122 side along the width direction of the base rail 100, while holding the other end portion 42 of the inlet member 4. When the operator carries out this operation, the operator inserts the one end portion 41 of the inlet member 4 toward the middle portion of the connecting portion 22 in the length direction of the base rail 100, while viewing the base rail 100 and the outlet member 2 from above. By performing the aforementioned operation, the male screw portion 41a is inserted into the female screw portion 22b. Subsequently, when the operator pivots the other end portion 42 while holding the other end portion 42 on the outside of the bottom surface B1 in top plan view, the male screw portion 41a is engaged in the female screw portion 22b. By performing the aforementioned operation, the one end portion 41 of the inlet member 4 is connected to the connecting portion 22. In this state, the one end portion 41 of the inlet member 4 is held in a state that the one end portion 41 does not fall off from the connecting portion 22 in the width direction of the base rail 100. Thus, the inlet channel 44 opened toward the male screw portion 41a is communicated with the communication channel 22c opened toward the female screw portion 22b.

When the aforementioned operation is performed, the operator adjusts the engagement position of the male screw portion 41a with respect to the female screw portion 22b in such a manner that the first projection 43a projects vertically upward, and comes into contact with the bottom surface B1. When it is difficult to adjust the axial orientation of the inlet member 4 in such a manner that the first projection 43a projects vertically upward, the operator may adjust the engagement position of the male screw portion 41a with respect to the female screw portion 22b in such a manner that the second projection 43b projects vertically upward.

3) Mounting Step

Subsequently, the operator places the holding plate 5 in such a manner that the pressing portion 51 is disposed above the second leg portion 122, and the tilt portion 52 is inclined downward toward the side opposite to the first leg portion 121. Then, the operator hooks the bent portion of the U-bolt 61 onto the second projection 43b, and inserts both ends of the U-bolt 61 into the oblong holes 52a and 52b formed in the tilt portion 52, respectively. After inserting both ends of the U-bolt 61 into the oblong holes 52a and 52b, the operator fastens both ends of the U-bolt 61, and the nuts 62a and 62b together, while keeping the U-bolt 61 orthogonal to the tilt portion 52. By performing the aforementioned operation, the U-bolt 61 is fixed in a state that a pulling force is exerted on the inlet member 4, utilizing the counterforce at the tilt portion 52, and the connecting portion 22 holding the inlet member 4 is pulled toward the base rail 100 side. As a result of the aforementioned operation, the opposing portion 22a is pressed against the first leg portion 121 while interposing the shim member 3. In this way, the foreign matter removing device Y1 is mounted on the base rail 100, and installation of the foreign matter removing device Y1 is completed.

When the operator fastens the U-bolt 61, and the nuts 62a and 62b together, the operator changes the position of the U-bolt 61 within the oblong holes 52a and 52b, as necessary, depending on the position of the second projection 43b. Specifically, when the second projection 43b is nearer to the connecting portion 22 in the width direction of the base rail 100, the operator places both ends of the U-bolt 61 at a position close to the upper ends of the oblong holes 52a and 52b, and fastens both ends of the U-bolt 61, and the nuts 62a and 62b together in this state. On the other hand, when the second projection 43b is nearer to the side opposite to the connecting portion 22 in the width direction of the base rail 100, the operator places both ends of the U-bolt 61 at a position close to the lower ends of the oblong holes 52a and 52b, and fastens both ends of the U-bolt 61, and the nuts 62a and 62b together in this state. In this way, the operator changes the relative position between the oblong holes 52a and 52b, and the U-bolt 61, as necessary. This makes it possible to change the relative position of the U-bolt 61 with respect to the inlet member 4 depending on the position of the second projection 43b. In this way, the U-bolt 61 is fixed onto the tilt portion 52 in a state that the tilt portion 52 and the U-bolt 61 are orthogonal to each other.

In the foreign matter removing device Y1 as described above, the inlet member 4 and the connecting portion 22 are separated from each other, and the one end portion 41 of the inlet member 4 is connected to the connecting portion 22 in a region lower than the bottom surface B1 of the base rail 100. The other end portion 42 of the inlet member 4 is disposed on the outside of the bottom surface B1 of the base rail 100 in top plan view. According to this configuration, the operator who installs the foreign matter removing device Y1 is allowed to place the outlet member 2 at a predetermined installation position from between the base rail 100 and the tongue rail 200, and to pivot the other end portion 42 while holding the other end portion 42 of the inlet member 4 in a region outside of the bottom surface B1 of the base rail 100 in top plan view. Then, the operator can connect the one end portion 41 of the inlet member 4 to the connecting portion 22, while inserting the inlet member 4 into the region lower than the bottom surface B1 of the base rail 100. This makes it easy for the operator to perform the installation operation, even when the region lower than the bottom surface B1 of the base rail 100 is narrow, and eliminates the need of performing a cumbersome fixing operation in the region lower than the bottom surface B1 of the base rail 100. This is advantageous in preventing lowering the work efficiency.

Further, in the foreign matter removing device Y1, the inlet member 4 has a linear shape from the one end portion 41 to the other end portion 42. Therefore, when the operator installs the foreign matter removing device Y1, the operator can easily pivot the other end portion 42 in a state that the inlet member 4 is inserted into the region lower than the bottom surface B1 of the base rail 100. This makes it easy for the operator to perform the operation of connecting the one end portion 41 to the connecting portion 22, while pivoting the other end portion 42. This is advantageous in enhancing the work efficiency.

Further, in the foreign matter removing device Y1, when the operator installs the foreign matter removing device Y1, the operator can easily connect the one end portion 41 to the connecting portion 22 by engaging the male screw portion 41a in the female screw portion 22b while pivoting the other end portion 42.

Further, in the foreign matter removing device Y1, the male screw portion 41a and the female screw portion 22b are disposed in the region lower than the bottom surface B1 of the base rail 100. This allows for the operator to hold the one end portion 41 of the inlet member 4 with respect to the connecting portion 22, while efficiently using the space lower than the bottom surface B1 of the base rail 100.

Further, in the foreign matter removing device Y1, the male screw portion 41a has a tapered shape. This makes it easy for the operator to adjust the axial orientation of the inlet member 4 when the operator engages the male screw portion 41a in the female screw portion 22b. In addition, engagement of the tapered male screw portion 41a in the female screw portion 22b makes it possible to prevent leakage of compressed air from between the one end portion 41 and the connecting portion 22. This eliminates the need of providing a gasket between the one end portion 41 and the connecting portion 22, and makes it possible to reduce the number of parts. In particular, in the embodiment, the nozzle portion 21 and the connecting portion 22 of the outlet member 2 are integrally formed. Therefore, there is no likelihood that compressed air leaks from a portion of the outlet member 2 other than the injection ports 21a. This is advantageous in enhancing the use efficiency of compressed air to be introduced from the compressed air source Z1 to the foreign matter removing device Y1.

Further, in the foreign matter removing device Y1, the oblong holes 52a and 52b are formed in the holding plate 5. Changing the position of the U-bolt 61 within the oblong holes 52a and 52b makes it possible to change the relative position of the U-bolt 61 with respect to the inlet member 4. According to this configuration, for instance, even when size error occurs in the length of the first leg portion 121 in the width direction of the base rail 100, and the position of the second projection 43b in a state that the foreign matter removing device Y1 is fixed to the base rail 100 is deviated, the operator can stably hook the U-bolt 61 onto the second projection 43b.

Further, in the foreign matter removing device Y1, no matter where the position of the U-bolt 61 is changed within the oblong holes 52a and 52b, the operator can fix the U-bolt 61 to the tilt portion 52 in a posture that the U-bolt 61 is orthogonal to the tilt portion 52. This is advantageous in stably fixing the U-bolt 61 to the tilt portion 52.

Further, in the foreign matter removing device Y1, one of the first projection 43a and the second projection 43b that project in the directions opposite to each other plays the role of an abutment portion with respect to the bottom surface B1 of the base rail 100, and the other of the first projection 43a and the second projection 43b plays the role of a portion to be hooked by the U-bolt 61. This makes it possible to reverse the roles of the first projection 43a and the second projection 43b depending on the orientation of the inlet member 4, and makes it easy for the operator to install the inlet member 4. Specifically, for instance, if only the first projection 43a playing the role of an abutment portion is provided out of the first projection 43a and the second projection 43b, and if the position of the first projection 43a with respect to the bottom surface B1 of the base rail 100 is deviated, the operator is required to adjust the first projection 43a to an appropriate position by rotating and fastening the male screw portion 41a with respect to the female screw portion 22b. In this case, the operator is required to rotate the male screw portion 22b maximally by a degree close to 360°. Unlike the aforementioned case, in the foreign matter removing device Y1, when it is difficult to use the first projection 43a as an abutment portion of the base rail 100 due to positional deviation of the first projection 43a with respect to the bottom surface B1 of the base rail 100, the operator can adjust the second projection 43b at an appropriate position as an abutment portion of the base rail 100 by rotating and fastening the male screw portion 41a with respect to the female screw portion 22b. In this configuration, the rotation amount of the male screw portion 22b is maximally 180° or smaller. Therefore, as compared with the aforementioned case where it is necessary to rotate the male screw portion 22 by a degree close to 360°, the operator can carry out the mounting operation with less force.

Further, in the foreign matter removing device Y1, providing the shim member 3 between the first leg portion 121 and the opposing portion 22a depending on manufacturing error in size of the base rail 100 makes it possible to set the relative position of the nozzle portion 21 with respect to the rail main body 110 at an optimum position.

Further, in the foreign matter removing device Y1, the clearance S1 is formed between the first side surface 111a of the base rail 100 and the nozzle portion 21. This makes it possible to reduce the likelihood that vibrations accompanied by running of a train are transmitted to the nozzle portion 21 via the base rail 100. This is advantageous in preventing concentration of stress on a connecting portion between the nozzle portion 21 and the connecting portion 22 due to transmission of the vibrations. In the aforementioned configuration, it is not necessary to finely adjust the position of the nozzle portion 21 so that the nozzle portion 21 comes into contact with the first side surface 111a depending on manufacturing error in size of the base rail 100. This makes it easy for the operator to perform the installation operation of the foreign matter removing device Y1.

In the embodiment, the operator connects the one end portion 41 to the connecting portion 22 by engagement of the male screw portion 41a in the female screw portion 22b. The embodiment is not limited to the above. The male screw portion 41a and the female screw portion 22b may be omitted.

For instance, a press-in hole may be formed in the inlet-member-4-side surface of the lower end 22B of the connecting portion 22 in the width direction of the base rail 100. Pressingly inserting the one end portion 41 into the press-in hole allows for the operator to connect the one end portion 41 to the connecting portion 22.

Further, the operator may connect the one end portion 41 to the connecting portion 22 using a pipe joint. The pipe joint is constituted of two parts. The operator mounts the one part of the pipe joint on the one end portion 41, and mounts the other part of the pipe joint on the connecting portion 22. In this state, the operator inserts the one end portion 41 into the region lower than the bottom surface B1 of the base rail 100, while holding the other end portion 42, and connects the one part and the other part of the pipe joint to each other in the region lower than the bottom surface B1. By performing the aforementioned operation, the one end portion 41 is connected to the connecting portion 22.

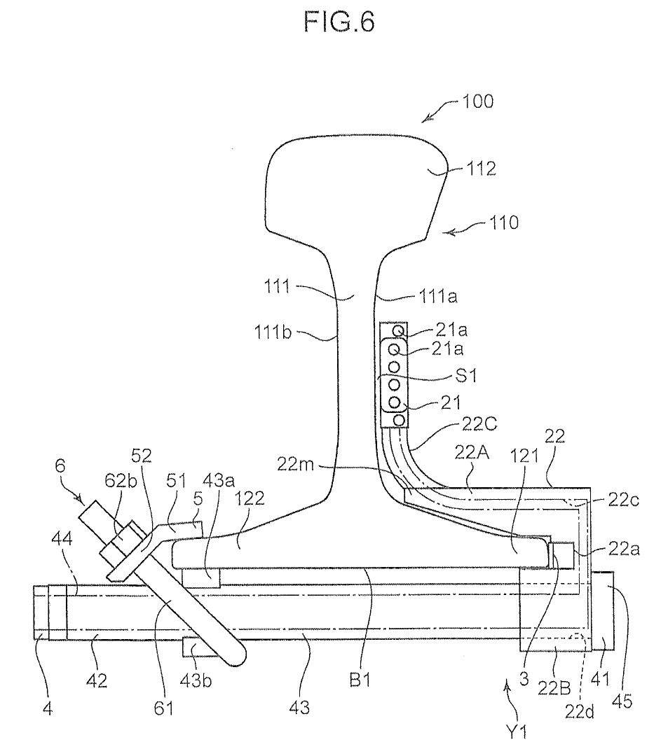

Further, in the modification illustrated in FIG. 6, the connecting portion 22 includes a through-hole 22d, in place of the female screw portion 22b, and the inlet member 4 includes a flange portion 45, in place of the male screw portion 41a.

The through-hole 22d is formed in a part of the connecting portion 22 in a region lower than the bottom surface B1 of the base rail 100. The through-hole 22d passes through the lower end 22B in the width direction of the base rail 100. The communication channel 22c is opened toward the upper portion of the inner surface of the lower end 22B forming the through-hole 22d.

The flange portion 45 is formed at the tip end of the one end portion 41 of the inlet member 4. The inlet channel 44 is opened toward the upper portion of the outer surface of the inlet member 4 on the other end portion 42 side with respect to the flange portion 45. The flange portion 45 has a diameter larger than the diameter of the through-hole 22d. Further, the portion of the inlet member 4 other than the flange portion 45 has a slightly smaller diameter than the diameter of the through-hole 22d.

The inlet member 4 is received in the through-hole 22d, and the flange portion 45 comes into contact with the tongue-rail-200-side surface of the lower end 22B. According to this configuration, the inlet member 4 is connected to the connecting portion 22. In this state, the inlet member 4 is held in a state that the one end portion 41 does not fall off from the connecting portion 22 on the side opposite to the tongue rail 200, while interposing the base rail 100 in the width direction of the base rail 100. Further, in this state, the communication channel 22c opened toward the upper portion of the inner surface of the lower end 22B, and the inlet channel 44 opened toward the upper portion of the outer surface of the inlet member 4 are communicated with each other.

In the modification illustrated in FIG. 6, in order to connect the inlet member 4 to the connecting portion 22, the operator inserts the other end portion 42 into the through-hole 22d from the tongue rail 200 side in a state that the flange portion 45 is held. Then, the operator holds the other end portion 42 that reaches the outside of the bottom surface B1 of the base rail 100 on the side opposite to the tongue rail 200 with respect to the base rail 100, and pulls the other end portion 42. By performing the aforementioned operation, the flange portion 45 is brought into contact with the tongue-rail-200-side surface of the lower end 22B.

As described above, in the modification illustrated in FIG. 6, after inserting the other end portion 42 into the through-hole 22d, the operator holds the other end portion 42 on the outside of the bottom surface B1 in top plan view, and pulls the other end portion 42. By performing the aforementioned operation, the operator can bring the flange portion 45 into contact with the tongue-rail-200-side surface of the lower end 22B, and can connect the one end portion 41 to the connecting portion 22.

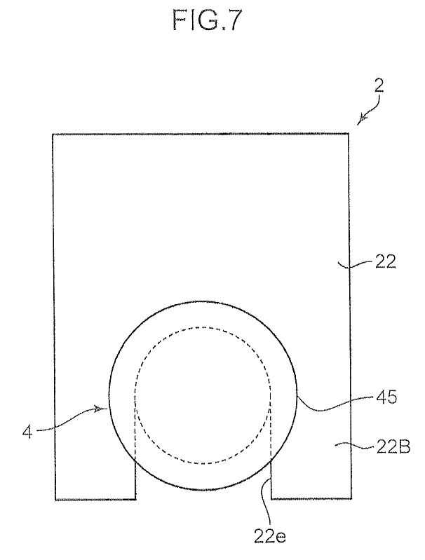

Alternatively, as illustrated in FIG. 7, the connecting portion 22 may include a recess portion 22e, in place of the through-hole 22d. The recess portion 22e is formed in the same position as the through-hole 22d. The recess portion 22e is formed to be recessed upward. In this case, the operator holds the other end portion 42 disposed on the outside of the bottom surface B1 on the side opposite to the tongue rail 200 with respect to the base rail 100 in a state that a part of the inlet member 4 is inserted into the region lower than the bottom surface B1, and lifts up the inlet member 4 for engaging the inlet member 4 into the recess portion 22e. Then, the operator can connect the one end portion 41 to the connecting portion by bringing the flange portion 45 into contact with the tongue-rail-22-side surface of the lower end 22B in a state that the inlet member 4 is engaged in the recess portion 22e.

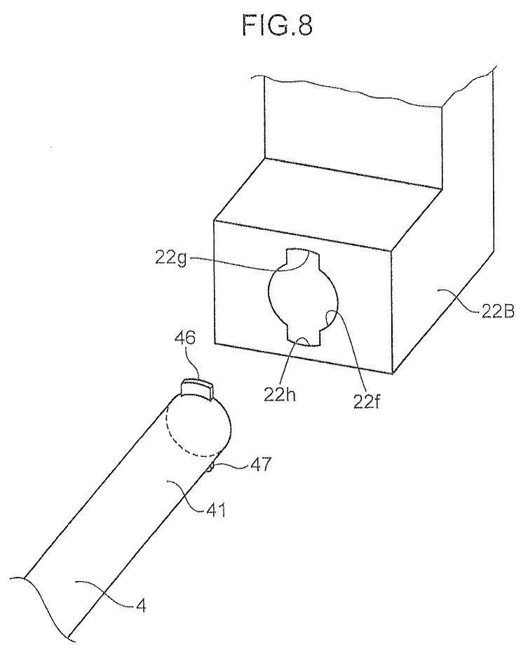

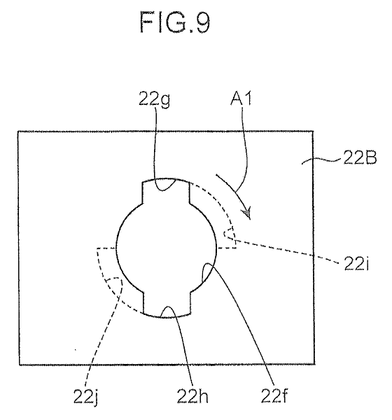

Further, in the modifications illustrated in FIG. 8 and FIG. 9, the inlet member 4 includes a first convex portion 46 and a second convex portion 47, in place of the male screw portion 41a. The connecting portion 22 includes an opening portion 22f in place of the female screw portion 22b. In FIG. 8, illustration of the base rail 100 is omitted in order to simplify the description. FIG. 9 is a front view of the inlet-member-4-side surface of the lower end 22B of the connecting portion 22 illustrated in FIG. 8 in the width direction of the base rail 100.

The first convex portion 46 is formed at the tip end of the one end portion 41. The first convex portion 46 radially projects in a certain direction from the one end portion 41. The second convex portion 47 is formed at the tip end of the one end portion 41. The second convex portion 47 radially projects from the one end portion 41 in a direction opposite to the first convex portion 46.

The opening portion 22f is configured such that a part of the inlet-member-4-side surface of the lower end 22B is recessed toward the tongue rail 200 side in the width direction of the base rail 100. The opening portion 22f includes a first concave portion 22g and a second concave portion 22h. The first concave portion 22g is a portion for receiving the first convex portion 46 when the operator inserts the one end portion 41 into the opening portion 22f. The second concave portion 22h is a portion for receiving the second convex portion 47 when the operator inserts the one end portion 41 into the opening portion 22f.

The lower end 22B of the connecting portion 22 includes a first groove portion 22i and a second groove portion 22j. Specifically, the first groove portion 22i is configured such that a part of the tongue-rail-200-side end of the opening portion 22f is radially recessed. A circumferential end of the first groove portion 22i is joined to the first concave portion 22g. The width of the first groove portion 22i is formed to be slightly larger than the thickness of the first convex portion 46. Further, the second groove portion 22j is configured such that a part of the tongue-rail-200-side end of the opening portion 22f is radially recessed. The second groove portion 22j is radially formed on the side opposite to the first groove portion 22i. A circumferential end of the second groove portion 22j is joined to the second concave portion 22h. The width of the first groove portion 22i is formed to be slightly larger than the thickness of the second convex portion 47.

When the operator installs the foreign matter removing device Y1 as the modifications illustrated in FIG. 8 and FIG. 9, the operator inserts the one end portion 41 of the inlet member 4 into the region lower than the bottom surface B1, while holding the other end portion 42 on the outside of the bottom surface B1 in top plan view. Then, the operator inserts the one end portion 41 of the inlet member 4 into the opening portion 22f, while positioning the first convex portion 46 with respect to the first concave portion 22g, and positioning the second convex portion 47 with respect to the second concave portion 22h. Lastly, when the one end portion 41 reaches the tongue-rail-200-side end of the opening portion 22f, the operator pivots the other end portion 42 in the arrow A1 direction illustrated in FIG. 9 on the outside of the bottom surface B1 in top plan view. By performing the aforementioned operation, the first convex portion 46 is engaged in the first groove portion 22i, and the second convex portion 47 is engaged in the second groove portion 22j.

As described above, in the modifications illustrated in FIG. 8 and FIG. 9, when the operator pivots the other end portion 42 on the outside of the bottom surface B1 in top plan view, the operator can engage the first convex portion 46 in the first groove portion 22i and engage the second convex portion 47 in the second groove portion 22j. This allows for the operator to connect the one end portion 41 to the connecting portion 22.

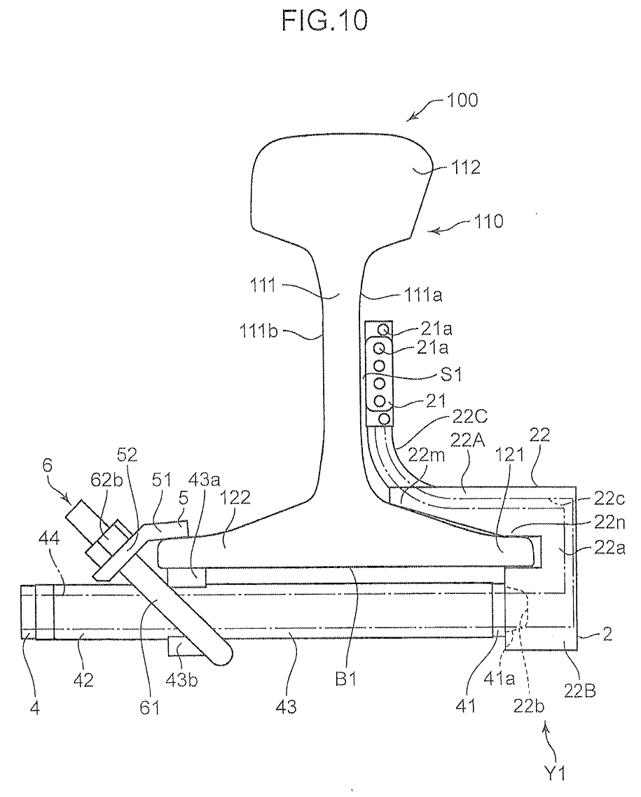

Further, in the modification illustrated in FIG. 10, the base rail 100 comes into contact with the inlet member 4 and with the connecting portion 22 at three points. Furthermore, in the modification illustrated in FIG. 10, the connecting portion 22 comes into contact with the first leg portion 121 from above at two points away from each other in the width direction of the base rail 100. The modification is described in detail as follows.

The inlet member 4 comes into contact with the leg portion 120 at the first projection 43a from below the leg portion 120. Specifically, the inlet member 4 comes into contact with the base rail 100 at one point from below the base rail 100.

The upper end 22A of the connecting portion 22 includes the tip end 22m and a base end 22n as both ends of the upper end 22A in the width direction of the base rail 100. The tip end 22m is disposed on the first portion 111 side and joined to the nozzle portion 21 via the joint portion 22C in the width direction of the base rail 100. The base end 22n is disposed on the side opposite to the tip end 22m and joined to the opposing portion 22a in the width direction of the base rail 100. The tip end 22m comes into contact with the upper surface of the first-portion-111-side portion of the first leg portion 121. The base end 22n comes into contact with the upper surface of the opposing-portion-22a-side portion of the first leg portion 121. Specifically, the upper end 22A of the connecting portion 22 comes into contact with the base rail 100 from above the base rail 100 at two points away from each other in the width direction of the base rail 100.

In the embodiment, the upper end 22A of the connecting portion 22 does not come into contact with the first-portion-111-side portion of the first leg portion 121, and comes into contact only with the opposing-portion-22a-side portion of the first leg portion 121. On the other hand, in the modification illustrated in FIG. 10, the tip end 22m of the upper end 22A of the connecting portion 22 comes into contact with the first-portion-111-side portion of the first leg portion 121 in a region vertically lower than the nozzle portion 21. Specifically, in the modification illustrated in FIG. 10, the connecting portion 22 comes into contact with the leg portion 120 of the base rail 100 on the side closer to the nozzle portion 21, as compared with the embodiment.

Further, in the modification illustrated in FIG. 10, unlike the embodiment, a shim member 3 is not provided. Therefore, in the modification illustrated in FIG. 10, a clearance is formed between the first leg portion 121 and the opposing portion 22a in the width direction of the base rail 100. Alternatively, the first leg portion 121 and the opposing portion 22a may come into contact with each other in the width direction of the base rail 100.

As described above, in the modification illustrated in FIG. 10, the inlet member comes into contact with the base rail 100 from below the base rail 100, and the connecting portion 22 comes into contact with the base rail 100 from above the base rail 100. According to this configuration, the base rail 100 is sandwiched between the inlet member 4 and the connecting portion 22. Therefore, it is easy for the operator to stably mount the foreign matter removing device Y1 on the base rail 100. Further, in the modification illustrated in FIG. 10, the foreign matter removing device Y1 comes into contact with the leg portion 120 at three points in such a manner that the leg portion 120 is vertically sandwiched between the upper and lower sides. This is advantageous in stably mounting the foreign matter removing device Y1 on the base rail 100.

Furthermore, in the modification illustrated in FIG. 10, the tip end 22m of the upper end 22A to be connected to the joint portion 22C comes into contact with the first leg portion 121 of the base rail 100. Specifically, in the modification illustrated in FIG. 10, the connecting portion 22 comes into contact with the leg portion 120 of the base rail 100 in the region vertically lower than the nozzle portion 21. The portion of the outlet member 2 on the nozzle portion 21 side with respect to the tip end 22m, in other words, the joint portion 22C and the nozzle portion 21 are in a cantilever state. In the modification illustrated in FIG. 10, it is possible to bring the contact point between the connecting portion 22 and the base rail 100 closer to the nozzle portion 21. This makes it possible to shorten the length of the joint portion 22C at the position of the joint portion 22C and the nozzle portion 21 in a cantilever state. This makes it possible to reduce the displacement of the nozzle portion 21 due to an influence of vibrations, and to reduce the stress on the nozzle portion 21. Specifically, it is possible to reduce the maximum stress on the nozzle portion 21 by about 40%, and to increase the safe rate by two times or more, as compared with the embodiment. Thus, it is possible to reduce the probability of damage of the nozzle portion 21 by vibrations.

Further, in the modification illustrated in FIG. 10, the connecting portion 22 comes into contact with the base rail 100 at two points i.e. at the tip end 22m and at the base end 22n away from each other in the width direction of the base rail 100. This makes it easy for the operator to stably install the foreign matter removing device Y1 when the operator installs the foreign matter removing device Y1 in the turnout X1.

Further, in the modification illustrated in FIG. 10, bringing the two points i.e. the tip end 22m and the base end 22n into contact with the base rail 100 makes it possible to stably mount the connecting portion 22 on the base rail 100. Therefore, it is not necessary to provide a shim member 3. This makes it possible to reduce the number of parts.

In addition, in the modification illustrated in FIG. 10, bringing the tip end 22m of the connecting portion 22 into contact with the first-portion-111-side portion of the first leg portion 121 makes it possible to reduce the probability of damage of the nozzle portion 21. This is advantageous in making the structure of the foreign matter removing device Y1 compact.

In the modification illustrated in FIG. 10, the connecting portion 22 is disposed to come into contact with the base rail 100 at two points i.e. at the tip end 22m and at the base end 22n. Alternatively, the connecting portion 22 may be disposed to come into contact with the base rail 100 at three or more points.

The embodiment and the modifications described above should be considered to be illustrative in all aspects and not to be restrictive. The scope of the present invention is indicated not by the description of the above embodiment and modifications, but by the scope of claims, and includes all changes within the meaning and range of equivalents to the scope of claims.

For instance, in the embodiment and the modifications, the holding plate 5 has a bent shape between the pressing portion 51 and the tilt portion 52, and the pressing portion 51 and the upper surface of the second leg portion 122 come into planar contact with each other. Alternatively, the holding plate 5 may have a flat shape without a bent portion. In this case, the flat-plate-shaped holding plate 5 is disposed to be inclined in such a manner that the holding plate 5 is bridged between the upper surface of the inlet member 4 and the upper surface of the tip end of the second leg portion 122, and comes into linear contact with the second leg portion 122.

Further, in the embodiment, after the operator places the outlet member 2 at a predetermined position of the base rail 100, the operator inserts the one end portion 41 of the inlet member 4 into the region lower than the bottom surface B1 from the second leg portion 122 side, and connects the one end portion 41 to the connecting portion 22. Alternatively, for instance, when the space lower than the bottom surface B1 of the base rail 100 is sufficiently large, or when it is possible to increase the space by digging the ballast below the bottom surface B1 of the base rail 100, it is possible to dispose the inlet member 4 in the region lower than the base rail 100 in a state that the inlet member 4 is connected to the outlet member 2, and thereafter, to fix the inlet member 4 to the base rail 100.

In this case, first of all, the operator connects the one end portion 41 of the inlet member 4 to the connecting portion 22 by engagement of the male screw portion 41a in the female screw portion 22b. Then, the operator disposes the connecting body of the outlet member 2 and the inlet member 4 in such a manner that the inlet member 4 is inserted into the region lower than the bottom surface B1 from the first leg portion 121 side, and that the nozzle portion 21 is inserted from below the tongue rail 200 into between the tongue rail 200 and the base rail 100. In this way, after the operator places the outlet member 2 and the inlet member 4 at a predetermined position of the base rail 100, the operator places the U-bolt 61 to be hooked onto the second projection 43b. Then, the operator inserts both ends of the U-bolt 61 into the oblong holes 52a and 52b of the holding plate 5 to fix the U-bolt 61 to the holding plate 5 by the nuts 62a and 62b. In this way, the foreign matter removing device Y1 is mounted on the base rail 100.

The following is the summary of the embodiment.

The aforementioned foreign matter removing device for use in a turnout is a foreign matter removing device for use in a turnout, wherein the foreign matter removing device is provided with a base rail, and a tongue rail disposed adjacent to the base rail and movable toward and away from the base rail. The foreign matter removing device is provided with an inlet member including an inlet channel for introducing a foreign matter removable medium, the inlet member extending in a width direction of the base rail in a region lower than a bottom surface of the base rail; and a connecting portion including a communication channel for communicating a nozzle portion which injects the foreign matter removable medium to between the base rail and the tongue rail, and the inlet channel. The connecting portion is connected to one end portion of the inlet member in the region lower than the bottom surface of the base rail. The other end portion of the inlet member disposed on the outside of the bottom surface of the base rail in top plan view is configured such that an operator is allowed to connect the one end portion of the inlet member to the connecting portion.

In the foreign matter removing device for use in a turnout, the inlet member and the connecting portion are separated from each other, and the one end portion of the inlet member is connected to the connecting portion in the region lower than the bottom surface of the base rail. The other end portion of the inlet member is disposed on the outside of the bottom surface of the base rail in top plan view. According to this configuration, the operator who installs the foreign matter removing device is allowed to place the connecting portion at a predetermined installation position from between the base rail and the tongue rail, and to operate the other end portion of the inlet member in the region outside of the bottom surface of the base rail in top plan view. Then, the operator is allowed to connect the one end portion of the inlet member to the connecting portion, while inserting the inlet member into the region lower than the bottom surface of the base rail. As described above, in the foreign matter removing device for use in a turnout, the inlet member and the connecting portion are separated from each other. Therefore, even when the space lower than the bottom surface of the base rail is narrow, it is easy for the operator to install the foreign matter removing device. Furthermore, there is no need of performing a cumbersome fixing operation in the region lower than the bottom surface of the base rail. This is advantageous in preventing lowering the work efficiency. Preferably, the inlet member may have a linear shape from the one end portion to the other end portion.

In the foreign matter removing device for use in a turnout, when the operator installs the foreign matter removing device, it is easy for the operator to pivot the other end portion of the inlet member in a state that the inlet member is inserted into the region lower than the bottom surface of the base rail. Therefore, it is easy for the operator to perform the operation of connecting the one end portion of the inlet member to the connecting portion, while pivoting the other end portion of the inlet member. This is advantageous in enhancing the work efficiency.

Preferably, the connecting portion may include a female screw portion. In this case, preferably, the one end portion of the inlet member may include a male screw portion engageable in the female screw portion.

In the foreign matter removing device for use in a turnout, when the operator installs the foreign matter removing device, the operator can easily connect the one end portion of the inlet member to the connecting portion by engaging the male screw portion in the female screw portion while pivoting the other end portion of the inlet member.

Preferably, the male screw portion may have a tapered shape toward a tip end of the one end portion.

In the foreign matter removing device for use in a turnout, the male screw portion has a tapered shape. Therefore, when the operator engages the male screw portion in the female screw portion, the operator can easily adjust the axial orientation of the inlet member. Further, engagement of the tapered male screw portion in the female screw portion makes it possible to prevent leakage of the foreign matter removable medium from between the one end portion of the inlet member and the connecting portion. Therefore, it is not necessary to provide a gasket between the one end portion of the inlet member and the connecting portion. This makes it possible to reduce the number of parts.

Preferably, the base rail may include a vertically extending rail main body, and a leg portion joined to a lower end of the rail main body, the leg portion including a first leg portion extending from the rail main body toward the tongue rail side, and a second leg portion extending toward the side opposite to the first leg portion. In this case, preferably, the connecting portion may include an opposing portion which faces the first leg portion in a width direction of the base rail. Preferably, the foreign matter removing device may further include a holding plate to be mounted on the second leg portion; and a pulling member to be hooked onto the inlet member, and to exert a pulling force on the inlet member in such a manner that the opposing portion is pressed against the first leg portion, utilizing a counterforce of the holding plate. In this case, preferably, the holding plate may hold the pulling member in such a manner that a relative position of the pulling member with respect to the inlet member is changeable in the width direction of the base rail.

In the foreign matter removing device for use in a turnout, the inlet member, and the connecting portion holding the inlet member are pulled by the pulling member toward the side opposite to the tongue rail in the width direction of the base rail. This causes the opposing portion to be pressed against the first leg portion, and fixes the relative position of the connecting portion and the nozzle portion with respect to the base rail. If size error occurs in the length of the first leg portion in the width direction of the base rail in carrying out the manufacturing process of the base rail, the position of the inlet member in the width direction may be deviated in a state that the opposing portion is pressed against the first leg portion. If the position of the inlet member in the width direction of the base rail is deviated, the pulling position of the pulling member with respect to the inlet member may also be deviated. In the foreign matter removing device for use in a turnout, it is possible to change the relative position of the pulling member with respect to the inlet member in the width direction of the base rail. Therefore, it is possible to change the relative position of the pulling member with respect to the inlet member in accordance with the deviation of the hook position. Thus, it is possible to hold the pulling member, whose relative position is changed, on the holding plate. According to this configuration, even if manufacturing error occurs in size of the base rail, it is possible to stably fix the foreign matter removing device with respect to the base rail.

Preferably, the inlet member may include, in the region lower than the bottom surface of the base rail, a first projection, and a second projection projecting toward the side opposite to the first projection. In this case, preferably, one of the first projection and the second projection may be brought into contact with the bottom surface of the base rail, and the other of the first projection and the second projection may be hooked by the pulling member.

In the foreign matter removing device for use in a turnout, one of the first projection and the second projection that project in the directions opposite to each other plays the role of an abutment portion with respect to the bottom surface of the base rail, and the other of the first projection and the second projection plays the role of a portion to be hooked by the pulling member. This makes it possible to reverse the roles of the first projection and the second projection depending on the orientation of the inlet member, as necessary. This makes it easy for the operator to place the inlet member.

Preferably, the foreign matter removing device may be further provided with a shim member disposed between the first leg portion and the opposing portion.

In the foreign matter removing device for use in a turnout, providing the shim member between the first leg portion and the opposing portion depending on manufacturing error in size of the base rail makes it possible to set the relative position of the nozzle portion with respect to the rail main body at an optimum position.

Preferably, the nozzle portion may be disposed between the base rail and the tongue rail. In this case, preferably, a clearance may be formed between the nozzle portion and the base rail.

The foreign matter removing device for use in a turnout is configured such that the nozzle portion is not brought into firm contact with the base rail. This eliminates the need of finely adjusting the relative position of the nozzle portion with respect to the base rail depending on manufacturing error in size of the base rail.

A method for installing a foreign matter removing device for use in a turnout of the invention is a method for installing a foreign matter removing device for use in a turnout, the foreign matter removing device being provided with a base rail, and a tongue rail disposed adjacent to the base rail and movable toward and away from the base rail. The method is provided with a disposing step of disposing a connecting portion at such a position that at least a part of the connecting portion is disposed in a region lower than a bottom surface of the base rail, the connecting portion including a communication channel for communicating with a nozzle portion which injects a foreign matter removal medium; and a connecting step of allowing an operator to operate the other end portion of an inlet member including an inlet channel for communicating with the communication channel and for introducing the foreign matter removal medium, on the outside of a bottom surface of the base rail in top plan view, so that the operator is allowed to connect one end portion of the inlet member to the connecting portion in the region lower than the bottom surface of the base rail while inserting the inlet member into the region lower than the bottom surface of the base rail.

In the method for installing a foreign matter removing device for use in a turnout, the inlet member and the connecting portion are separated from each other. The operator is allowed to insert the inlet member into the region lower than the bottom surface of the base rail, while placing the connecting portion at a predetermined installation position from between the base rail and the tongue rail. This makes it easy for the operator to install the foreign matter removing device, even when the space lower than the bottom surface of the base rail is narrow. Further, the operator is allowed to connect the one end portion of the inlet member to the connecting portion by operating the other end portion of the inlet member in the region outside of the bottom surface of the base rail in top plan view. This eliminates the need of performing a cumbersome fixing operation in the region lower than the bottom surface of the base rail. This is advantageous in preventing lowering the work efficiency.

This application is based on Japanese Patent Application No. 2014-186650 and Japanese Patent Application No. 2014-240211 respectively filed in Japan Patent Office on Sep. 12, 2014 and Nov. 27, 2014, the contents of which are hereby incorporated by reference.

Although the present invention has been fully described by way of example with reference to the accompanying drawings, it is to be understood that various changes and modifications will be apparent to those skilled in the art. Therefore, unless otherwise such changes and modifications depart from the scope of the present invention hereinafter defined, they should be construed as being included therein.

What is claimed is:

1. A foreign matter removing device for use in a turnout, the foreign matter removing device provided with a base rail, and a tongue rail disposed adjacent to the base rail and movable toward and away from the base rail, comprising:
an inlet member including an inlet channel for introducing a foreign matter removable medium, the inlet member extending in a width direction of the base rail in a region lower than a bottom surface of the base rail; and
a connecting portion including a communication channel for communicating a nozzle portion which injects the foreign matter removable medium to between the base rail and the tongue rail, and the inlet channel, wherein
the connecting portion is connected to one end portion of the inlet member in the region lower than the bottom surface of the base rail, and
the other end portion of the inlet member disposed on the outside of the bottom surface of the base rail in top plan view is configured such that an operator is allowed to connect the one end portion of the inlet member to the connecting portion.

2. The foreign matter removing device for use in a turnout according to claim 1, wherein
the inlet member has a linear shape from the one end portion to the other end portion.

3. The foreign matter removing device for use in a turnout according to claim 1, wherein
the connecting portion includes a female screw portion, and the one end portion of the inlet member includes a male screw portion engageable in the female screw portion.

4. The foreign matter removing device for use in a turnout according to claim 3, wherein
the male screw portion has a tapered shape toward a tip end of the one end portion.

5. The foreign matter removing device for use in a turnout according to claim 1, wherein
the base rail includes a vertically extending rail main body, and a leg portion joined to a lower end of the rail main body, the leg portion including a first leg portion extending from the rail main body toward the tongue rail side, and a second leg portion extending toward the side opposite to the first leg portion,
the connecting portion includes an opposing portion which faces the first leg portion in a width direction of the base rail,
the foreign matter removing device further includes:
a holding plate to be mounted on the second leg portion; and
a pulling member to be hooked onto the inlet member, and to exert a pulling force on the inlet member in such a manner that the opposing portion is pressed against the first leg portion, utilizing a counterforce of the holding plate, and
the holding plate holds the pulling member in such a manner that a relative position of the pulling member with respect to the inlet member is changeable in the width direction of the base rail.

6. The foreign matter removing device for use in a turnout according to claim 5, wherein
the inlet member includes, in the region lower than the bottom surface of the base rail, a first projection, and a second projection projecting toward the side opposite to the first projection,
one of the first projection and the second projection is brought into contact with the bottom surface of the base rail, and
the other of the first projection and the second projection is hooked by the pulling member.

7. The foreign matter removing device for use in a turnout according to claim 5, further comprising:
a shim member disposed between the first leg portion and the opposing portion.

8. The foreign matter removing device for use in a turnout according to claim 1, wherein
the nozzle portion is disposed between the base rail and the tongue rail, and
a clearance is formed between the nozzle portion and the base rail.

9. The foreign matter removing device for use in a turnout according to claim 1, wherein
the inlet member comes into contact with the base rail at at least one point from below the base rail,
the connecting portion comes into contact with the base rail at at least one point from above the base rail, and
the base rail comes into contact with the inlet member and with the connecting portion at at least three points.

10. A foreign matter removing device for use in a turnout, the foreign matter removing device provided with a base rail, and a tongue rail disposed adjacent to the base rail and movable toward and away from the base rail, comprising:
an inlet member including an inlet channel for introducing a foreign matter removable medium, the inlet member extending in a width direction of the base rail in a region lower than a bottom surface of the base rail; and
a connecting portion including a communication channel for communicating a nozzle portion which injects the foreign matter removable medium to between the base rail and the tongue rail, and the inlet channel, the connecting portion being configured to be connected to one end portion of the inlet member, wherein
the inlet member comes into contact with the base rail at at least one point from below the base rail,
the connecting portion comes into contact with the base rail at at least one point from above the base rail, and
the base rail comes into contact with the inlet member and with the connecting portion at at least three points.

11. The foreign matter removing device for use in a turnout according to claim 9, wherein
the connecting portion includes an upper end formed on a side vertically opposite to the inlet member with respect to the base rail, and includes a joint portion for connecting a tip end of the upper end formed on a side away from the tongue rail in a width direction of the base rail, and the nozzle portion, and
the connecting portion comes into contact with the base rail at least at the tip end of the upper end.

12. The foreign matter removing device for use in a turnout according to claim 11, wherein
the connecting portion comes into contact with the base rail at a position away from the tip end of the upper end in the width direction of the base rail.

13. A method for installing a foreign matter removing device for use in a turnout, the foreign matter removing device being provided with a base rail, and a tongue rail disposed adjacent to the base rail and movable toward and away from the base rail, the method comprising:
a disposing step of disposing a connecting portion at such a position that at least a part of the connecting portion is disposed in a region lower than a bottom surface of the base rail, the connecting portion including a communication channel for communicating with a nozzle portion which injects a foreign matter removal medium; and
a connecting step of allowing an operator to operate the other end portion of an inlet member including an inlet channel for communicating with the communication channel and for introducing the foreign matter removal medium, on the outside of a bottom surface of the base rail in top plan view, so that the operator is allowed to connect one end portion of the inlet member to the connecting portion in the region lower than the bottom surface of the base rail while inserting the inlet member into the region lower than the bottom surface of the base rail.
